(19) United States
(12) Patent Application Publication
(10) Pub. No.: US 2023/0008777 A1
(43) Pub. Date: Jan. 12, 2023

(54) ACCELERATING CONVOLUTIONS FOR SPARSE INPUTS

(71) Applicant: Waymo LLC, Mountain View, CA (US)

(72) Inventor: David Seetapun, Berkeley, CA (US)

(21) Appl. No.: 17/371,486

(22) Filed: Jul. 9, 2021

(51) Int. Cl. G06N 3/04

(52) U.S. Cl. CPC G06N 3/04

(57) ABSTRACT

Methods, systems, and apparatus, including computer programs encoded on a computer storage medium, for performing an accelerated convolution on sparse inputs. In one aspect, a method comprises receiving sensor data input comprising input features for input spatial locations; and processing the sensor data input using a convolutional neural network having a first convolutional layer with a filter having multiple filter spatial locations to generate a network output comprising output features for output spatial locations, wherein processing the sensor data input comprises: obtaining a rule book tensor that identifies for each filter spatial location (i) a subset of the input features, and (ii) for each input feature in the subset, a respective output feature; for each particular filter spatial location: generating input tile, filter tile, and output tile sets in accordance with the rule book tensor; and generating the output features in the output tile set based on the tile sets.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that perform an accelerated convolution for sparse inputs.

According to a first aspect there is provided a method performed by one or more computers, the method comprising: receiving a sensor data input, the sensor data input comprising respective input features for each of a plurality of input spatial locations; and processing the sensor data input using a convolutional neural network to generate a network output that characterizes the sensor data input, wherein the convolutional neural network comprises a first convolutional layer that is configured to perform a convolution between (i) respective input features for each of a set of input spatial locations for the first convolutional layer and (ii) a filter for the first convolutional layer that has a plurality of filter spatial locations to generate respective output features for each of a set of output spatial locations for the first convolutional layer, and wherein processing the sensor data input comprises: obtaining a rule book tensor for the first convolutional layer that identifies, for each of the plurality of filter spatial locations, (i) a subset of the input features that are multiplied by the filter spatial location as part of performing the convolution and (ii) for each input feature in the subset, the respective output feature that is generated based at least in part on the multiplication between the input feature and the filter spatial location; for each particular filter spatial location of the filter for the first convolutional layer: generating an input tile set that includes only the respective input features that are identified in the rule book tensor for the particular filter spatial location; generating a filter tile set that includes the particular filter spatial location; generating an output tile set that includes only the respective output features that are identified in the rule book tensor for the particular filter spatial location; and generating a respective output for each of the respective output features in the output tile set by multiplying the particular filter spatial location in the filter tile set with each of the input features in the input tile set; and for each of the output features in the output tile set, writing the respective output for the output feature to a memory location in global device memory corresponding to the output feature.

In some implementations, the respective input features for each of a set of input spatial locations for the first convolutional layer are arranged as rows in an input matrix with an accompanying set of tuples arranged as rows in an input coordinate matrix specifying the respective input spatial coordinates and the respective row in the input matrix of each input feature.

In some implementations, each particular filter spatial location is arranged as a matrix of numerical values.

In some implementations, the respective output features for each of a set of output spatial locations for the first convolutional layer are arranged as rows in an output matrix with an accompanying set of tuples arranged as rows in an output coordinate matrix specifying the respective output spatial coordinates and the respective row in the output matrix of each output feature.

In some implementations, obtaining a rule book tensor for the first convolutional layer comprises iterating over each input feature to determine (i) the respective subset of output features generated based at least in part on the input feature, and (ii) for each output feature in the respective subset, which filter spatial location is multiplied by the input feature to generate the respective output feature.

In some implementations, the rule book tensor for the first convolutional layer is arranged as a set of matrices, each matrix specifying for a particular filter spatial location a set of input-output tuples arranged as rows in the matrix, each input-output tuple defining (i) which respective row of the input matrix is multiplied by the particular filter spatial location to generate, at least in part, (ii) which respective row of the output matrix.

In some implementations, generating an input tile set that includes only the respective input features that are identified in the rule book tensor for the particular filter spatial location comprises: arranging only the respective input features identified in the rule book tensor for the particular filter spatial location as rows in a respective input matrix; determining a first respective matrix size; and generating, from the respective input matrix, a set of matrices, each matrix in the set of matrices having the first respective matrix size and each matrix in the set of matrices corresponding to a respective tile in the set of input tiles.

In some implementations, generating a filter tile set that includes the particular filter spatial location comprises: determining a second respective matrix size; and generating, from the particular filter spatial location matrix, a set of matrices, each matrix in the set of matrices having the second respective matrix size and each matrix in the set of matrices corresponding to a respective tile in the set of filter tiles.

In some implementations, generating an output tile set that includes only the respective output features that are identified in the rule book tensor for the particular filter spatial location comprises: arranging only the respective output features identified in the rule book tensor for the particular filter spatial location as rows in a respective output matrix; determining a third respective matrix size; and generating, from the respective output matrix, a set of matrices, each matrix in the set of matrices having the third respective matrix size and each matrix in the set of matrices corresponding to a respective tile in the set of output tiles.

In some implementations, the processing is performed at least in part on a hardware accelerator chip, and wherein the first, second, and third respective matrix sizes are determined based on one or more properties of the hardware accelerator chip.

In some implementations, generating a respective output for each of the respective output features in the output tile set by multiplying the particular filter spatial location in the filter tile set with each of the input features in the input tile set comprises: for each output tile in the set of output tiles: transferring the output tile to the shared memory for a respective thread block; for each input tile in the respective input tile set processed to generate the output tile: transferring the respective input tile in the input tile set to the shared memory for the respective thread block; for each input tile in the respective filter tile set processed with respect to the respective input tile to generate the respective output tile: transferring the respective input tile in the respective filter tile set to the shared memory for the respective thread block.

In some implementations, generating a respective output for each of the respective output features in the output tile set by multiplying the particular filter spatial location in the filter tile set with each of the input features in the input tile set further comprises: for each output tile in the set of output tiles: generating a set of output partitions by partitioning the output tile transferred to the respective thread block among the registers of the respective threads in the respective thread block; for each input tile in the respective input tile set processed to generate the output tile: generating a set of input partitions by partitioning the respective input tile transferred to the respective thread block among the respective registers of the respective threads in the respective thread block; for each input tile in the respective filter tile set processed with respect to the respective input tile to generate the respective output tile: generating a set of filter partitions by partitioning the respective filter tile transferred to the respective thread block among the respective registers of the respective threads in the respective thread block; for each of a plurality of pairs of partitions, each pair comprising a respective first partition from the set of input partitions of the input tile set and a respective second partition from the set of filter partitions from the filter tile set: generating an inner product of the pair of partitions; and accumulating the result of the inner product in the respective register corresponding to the respective partition of the output tile.

In some implementations, accumulating the result of the inner product in a respective register corresponding to the respective partition of the output tile comprises adding the respective inner product to any inner products already stored in the register.

In some implementations, writing the respective output for the output feature to the memory location in global device memory corresponding to the output feature comprises: generating the respective output, comprising transferring the partitions of the respective output tiles corresponding to the output feature from the registers of the respective threads of the respective thread block to the shared memory of the thread block; and adding the respective output to any outputs already stored in the respective memory location in global device memory corresponding to the output feature.

Particular embodiments of the subject matter described in this specification can be implemented so as to realize one or more of the following advantages.

The system described in this specification can accelerate convolutions for sparse inputs using a hardware accelerator chip. The system can be configured to perform a convolution between the respective input features for each of a set of input spatial locations for a first convolutional layer and a filter for the first convolutional layer that has multiple filter spatial locations to generate respective output features for each of a set of output spatial locations for the first convolutional layer. Inputs can be considered sparse if only a small subset of the set of inputs to the system are above a “ground state” (i.e., an input representing a lowest possible state, such as a vector of all zeros). The system can perform the convolution by processing only the inputs which are above the ground state, which can enable the system to perform the convolution with fewer computational resources (e.g., memory and processing power).

The system can perform the convolution between each filter spatial location and the respective input features multiplied by the filter to generate respective output features using only a single kernel call to a hardware accelerator chip. A hardware accelerator chip is a general purpose device designed to accelerate certain classes of programs, and a kernel is a program executed on the device. That is, a kernel is a list of instructions to the hardware accelerator chip on how to perform an intended operation. Performing the convolution using only a single kernel call to the hardware accelerator chip can increase the efficiency of the convolution, reducing the quantity of memory traffic on the hardware accelerator chip and therefore the time the hardware accelerator chip spends waiting on the memory transfers, which can enable the convolution to be performed more quickly and efficiently, e.g., by a system on-board a self-driving vehicle.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example on-board system.

FIG. 2 is a block diagram of an example sparse convolution system.

FIG. 3 is a flow diagram of an example process for performing a sparse convolution.

FIG. 4 is a diagram illustrating an example convolution on a hardware accelerator chip.

Like reference numbers and designations in the various drawings indicate like elements.

### DETAILED DESCRIPTION

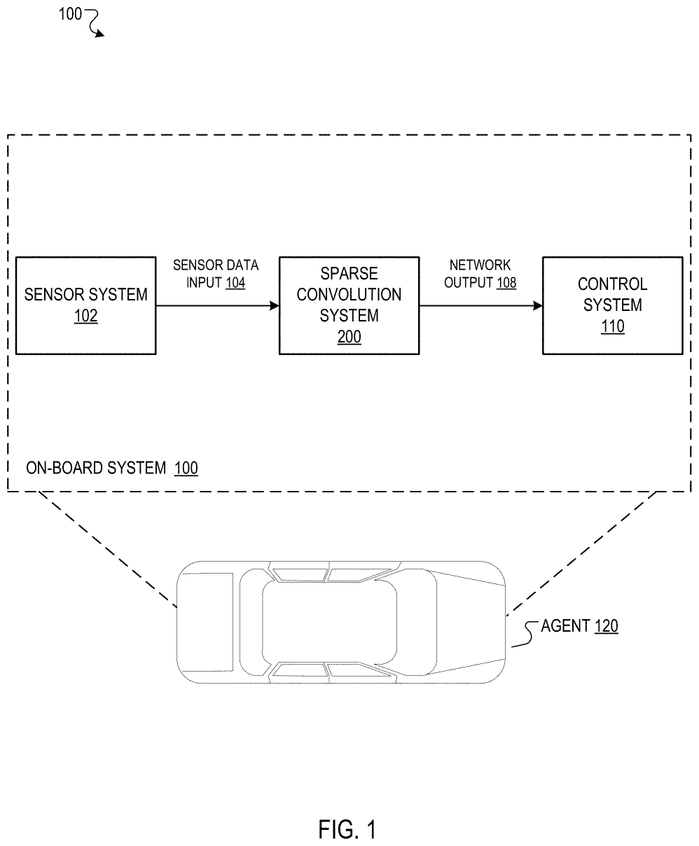

FIG. 1 shows an example on-board system 100. The on-board system 100 is an example of a system implemented as computer programs on one or more computers in one or more locations in which the systems, components, and techniques described below are implemented.

The on-board system 100 is a system that can process sensor data input using a neural network that includes one or more convolutional layers to generate a network output that characterizes the sensor data input.

The on-board system 100 can include a sensor system 102, a sparse convolution system 200, and a control system 110. For example, the sensor system 102 can obtain sensor data 104, and the sparse convolution system 200 can process the sensor data 104 to generate a network output 108 that characterizes the sensor data input 104. The control system 110 can process the network output 108 to perform any of a variety of tasks, as is discussed in further detail below.

The sensor system 102 can obtain sensor data 104 from any of a variety of sensors. For example, the sensor system 102 can obtain sensor data from, e.g., a lidar detector or other laser sensor, or a camera, e.g., an RGB camera, or both. Generally, the sensor data 104 includes respective input features for each of a set of input spatial locations.

The sparse convolution system 200 can process the sensor data input 104 using a convolutional neural network to generate a network output 108 that characterizes the sensor data input 104. For example, the network output 108 can include an object detection output (e.g., an output identifying the locations of bounding boxes that correspond to detected objects in the sensor data input), a classification output (e.g., identifying objects such as road signs, traffic lights, or other agents), or a behavior prediction output (e.g., predicted positions and velocities of other agents in the environment at one or more future time steps).

The sparse convolution system 200 can be configured to process any appropriate sensor data input, e.g., image sensor data input, lidar sensor data input, video sensor data input, audio sensor data input, hyper-spectral sensor data input, or any combination thereof. Sensor data input can be considered sparse if only a small subset of the sensor data input are above a ground state.

For example, sensor data input representing an image can include, e.g., intensity values of the pixels of the image, and the sensor data input can be considered sparse if only a small subset of the pixels have non-zero intensity values or non-zero color value vectors (e.g., RGB).

As another example, sensor data input that represents a measurement from a laser sensor, e.g., a lidar sensor, can be generated by projecting each three-dimensional point in the laser sensor measurement, i.e., each point representing a reflection of laser light, to a respective location in a two-dimensional grid, with each input feature corresponding to one of the projected points, i.e., having a two-dimensional spatial location in the two-dimensional grid. The input features for a given location in the two-dimensional grid include features of the points that have been projected to given location, e.g., the intensity of the three-dimensional points and, optionally, one or more other features of the three-dimensional points, e.g., the second return, elongation and so on. Because lidar scans are generally sparse, the corresponding sensor data input will also generally be sparse, i.e., include features for only a small subset of the locations in the two-dimensional grid.

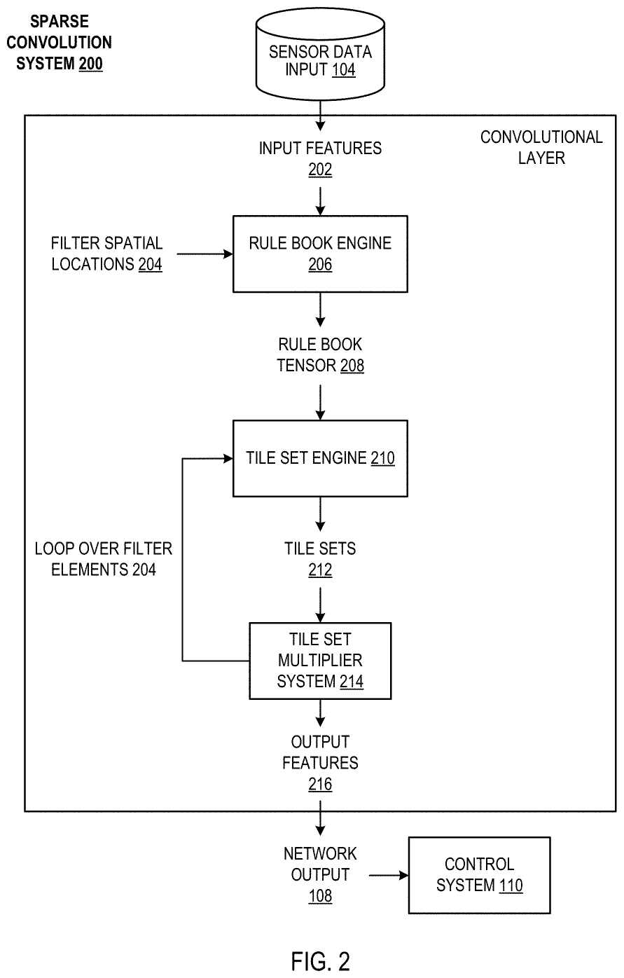

The operations performed by the sparse convolution system 200 to generate the network output 108 will be described in more detail below with reference to FIGS. 2-4.

The control system 110 can process the network output 108 to perform any of a variety of tasks. For example, the control system 110 can process the network output 108 to generate control decisions (e.g., accelerate, decelerate, turn left, turn right, ascend, descend, etc.) for controlling the movement of the host agent (e.g., an autonomous vehicle or robot).

The on-board system 100 can deployed on-board an agent, e.g., the agent 120. The on-board system 100 can operate on any of a variety of agents, e.g., on-board a remotely controlled agent, a robotic agent, or a (semi- or fully-)autonomous (land, sea, air, or space) vehicle. However, more generally, the described techniques can be applied to more efficiently process any kind of sensor data input captured from sensors of any type of agent. For example, the on-board system 100 can be embedded in a mobile phone or other edge computing device or can be deployed in a data center or other cloud system of multiple computers that receives the sensor data input remotely over a data communication network.

FIG. 2 shows an example sparse convolution system 200. The sparse convolution system 200 is an example of a system implemented as computer programs on one or more computers in one or more locations in which the systems, components, and techniques described below are implemented.

The sparse convolution system 200 can process sensor data input 104 using a convolutional neural network that has one or more convolutional layers to generate a network output 108 that characterizes the sensor data input 104. If the sensor data input 104 is sparse, then the output from some or all of the layers in the convolutional network can also be sparse. For example, if the sensor data input 104 represents, e.g., sparse lidar data, then the layer output of each convolutional layer in a sequence of convolutional layers will be sparse if no layer dilates the layer input to the layer.

Generally, the convolutional neural network includes multiple convolutional neural network layers that each generate a layer output from a layer input.

The layer input for any given convolutional neural network layer includes respective input features for each of a set of input spatial locations. The convolutional neural network layer is configured to generate the layer output by performing a convolution between (i) the layer input and (ii) a filter for the given convolutional layer to generate respective output features for each of a set of output spatial locations for the first convolutional layer. Depending on the properties of the filter, the set of output spatial locations can either be the same as or different from the set of input spatial locations. In some cases, the respective output features are the layer output of the convolutional layer. In some other cases, the convolutional layer is configured to perform one or more other operations on the respective output features, e.g., adding a bias term to the output features, applying an activation function to the output features, or both, to generate the layer output.

Generally, the system represents the layer input as a set of sparse input features and, for each of the input features, data identifying the respective input spatial location corresponding to the input features. In some implementations, the system can arrange the sparse input features to a convolutional layer as an input matrix, where each row in the input matrix is a feature vector corresponding to a non-empty input spatial location (i.e., a feature vector which is above the ground state). The system can generate a corresponding input location matrix, where each row in the input location matrix identifies a corresponding row in the input matrix and the input spatial coordinates corresponding to the feature vector identified by the row number.

Generally, the system represents the convolution output as a set of sparse output features and, for each of the output features, data identifying the respective output spatial location corresponding to the output features. In some implementations, the system can arrange the sparse output features from a convolutional layer as an output matrix, where each row in the output matrix is a feature vector corresponding to a non-empty output spatial location (i.e., a feature vector which is above the ground state). The system can generate a corresponding output location matrix, where each row in the output location matrix identifies a corresponding row in the output matrix and the output spatial coordinates corresponding to the feature vector identified by the row number.

Generally, a filter of a convolutional layer includes one or more filter spatial locations. The system can represent the filter as a tensor of numerical values, e.g., of dimensions F×C×D, where F is the number of filter spatial locations, C is the number of features for an output spatial location, and D is the number of features for an input spatial location.

In some implementations, the convolutional neural network can include additional neural network layers of other types. Generally, the convolutional neural network can include any additional types of neural network layers that enable it to perform its described function, i.e., processing sensor data input to generate a network output that characterizes the sensor data input. In particular, the convolutional neural network can include any appropriate types of neural network layers (e.g., fully-connected layers, attention-layers, convolutional layers, etc.) in any appropriate numbers (e.g., 1 layer, 5 layers, or 25 layers), and connected in any appropriate configuration (e.g., as a linear sequence of layers).

For any given convolutional layer in the convolutional neural network, and for any given filter corresponding to the given convolutional layer, the sparse convolution system 200 can perform the convolution between the input features 202 for the layer and filter spatial locations 204 of the given filter of the layer using a rule book engine 206, a tile set engine 210, and a tile set multiplier system 214 using a hardware accelerator chip, e.g., a graphics processing unit (GPU). In practice, this can be done for each of the one or more convolutional layers in the neural network, and for each of the one or more filters corresponding to each convolutional layer. For convenience, the process is described in further detail below for a single filter in a single convolutional layer, which can be repeated for each of one or more filters in each of one or more convolutional layers.

The rule book engine 206 can process the input features 202 and filter spatial locations 204 to generate a rule book tensor 208 for the filter. For example, the rule book engine 206 can iterate over the input features to determine, (i) for each input feature, the respective subset of output features that are generated based at least in part on the input feature, and, (ii) for each output feature in the respective subset, which filter spatial location is multiplied by the input feature to generate the respective output feature. The rule book engine 204 can arrange this information into a tensor, e.g., a tensor of dimensions F×N×2, where F is the number of filter spatial locations and N is the number of input features. For a filter spatial location f, the rule book tensor can identify an input feature n in the respective subset of input features for the filter spatial location with the entry (f,n,0), and for the input feature n, the respective output feature generated with the entry (f,n,1). If the subset of input features multiplied by the filter spatial location is a proper subset of the set of input features, the N×2 matrix for a filter spatial location can have more rows than respective input features for the filter spatial location. The rule book engine can fill any remaining rows of the matrix not identifying a respective input feature multiplied by the filter spatial location with, e.g., negative entries, to signify an end to the subset.

In some implementations, such as when the convolutional neural network has a linear sequence of convolutional layers with the first convolutional layer in the linear sequence being the input layer of the convolutional neural network, the rule book engine 206 can construct the rule book tensor 208 per input, e.g., per point cloud from a lidar detector, for each of the convolutional layers in the linear sequence of convolutional layers. In other implementations, such as architectures involving multiple types of neural network layers (e.g., fully-connected layer sequences followed by convolutional layer sequences), the rule book engine 206 can construct the rule book tensor 206 for each of multiple convolutional layers in a linear sequence of convolutional layers after receiving the output from the layer prior to the convolutional layer sequence.

After the rule book tensor 208 has been generated, the sparse convolution system 200 can generate the output features for the convolutional layer by iterating over the filter spatial locations 204. The sparse convolution system 200 can perform the convolution using only a single kernel call (that is, send a single set of instructions for the operation). For example, for each filter spatial location, the sparse convolution system 200 can generate respective tile sets 212 using a tile set engine 210, and process the respective tile sets 212 using a multiplier system 214 to generate the respective output features that depend on the filter spatial location.

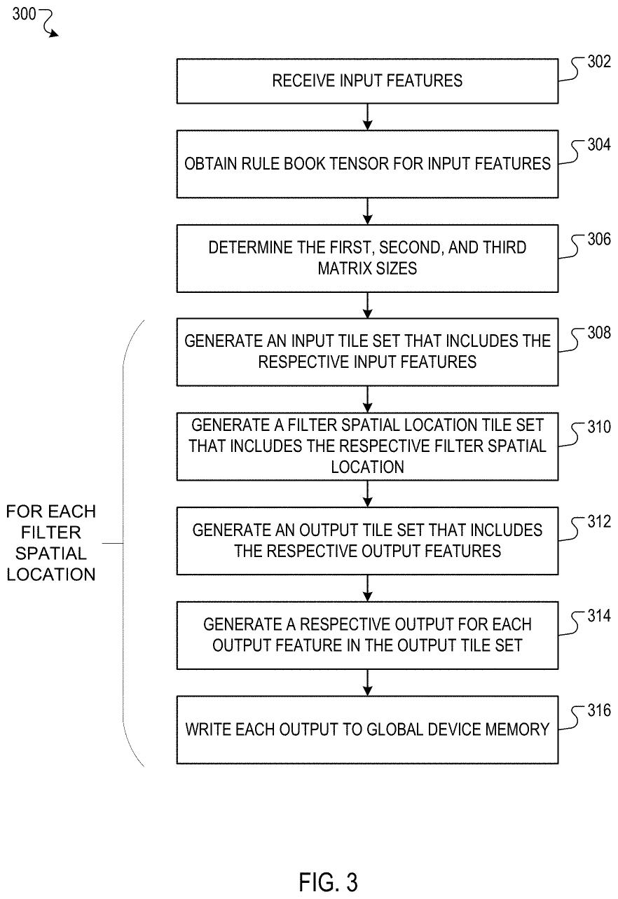

For each particular filter spatial location, the tile set engine 210 generates respective tile sets 212 by processing the rule book tensor 208, the particular filter spatial location, and the input features 202 for the convolutional layer. A tile set is a representation of the tensor processed to generate the tile set, where each tile in the tile set corresponds to a subsection of the tensor such that the tensor is fully represented by the tile set. Performing the convolution using a single kernel call to a hardware accelerator chip can reduce the time the hardware accelerator chip spends waiting on memory traffic, thereby enabling the sparse convolution system 200 to take fuller advantage of the parallel capabilities of the hardware accelerator chip to process the tile set representations. For example, the tile sets 212 can include an input tile set that includes only the respective input features identified by the rule book tensor 208 for the particular filter spatial location, i.e., and not any input features that are not identified by the rule book tensor 208 for the particular filter spatial location, a filter spatial location tile set that includes only the particular filter spatial location, and an output tile set that includes only the respective output features identified by the rule book tensor 208 for the particular filter spatial location, as is discussed in further detail below with reference to FIG. 3.

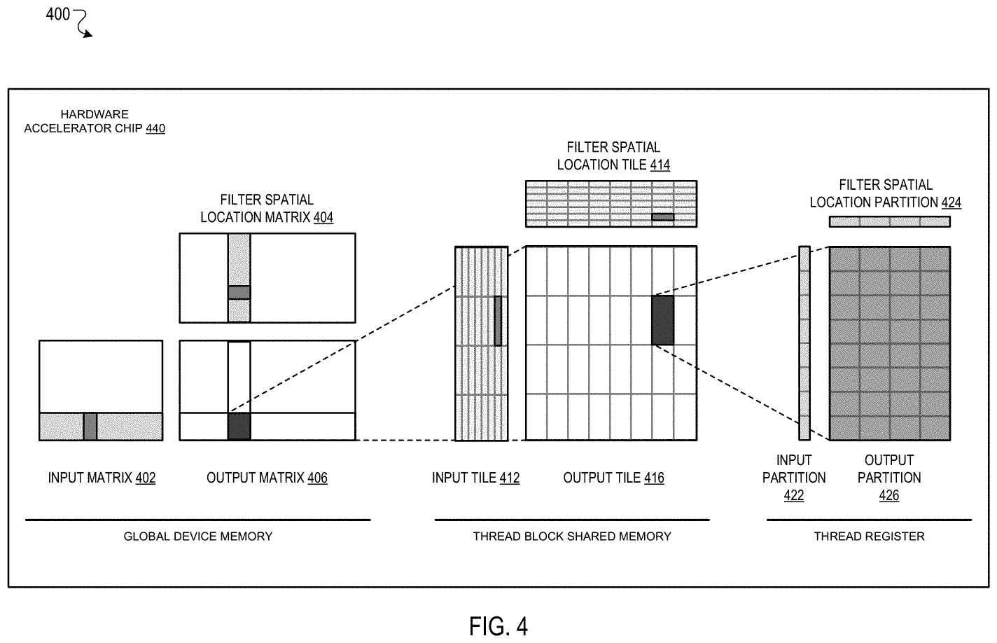

For each particular filter spatial location, the tile set multiplier system 214 can generate a respective output for each output feature in the output tile set for the particular filter spatial location by processing the respective tile sets 212. For example, the tile set multiplier system 214 can multiply the particular filter spatial location in the filter spatial location tile set by each input feature in the respective input tile set to generate the respective output features in the respective output tile set. The generation of the output features is discussed in further detail below with reference to FIG. 4.

The sparse convolution system 200 can combine the respective output features generated from each filter spatial location to generate the output features 216. For example, the sparse convolution system 200 can combine the respective output features by summing any output features corresponding to the same output spatial location.

The sparse convolution system 200 can then process the output features 216 in any appropriate manner to generate network output 108, e.g., using subsequent neural network layers of any appropriate type, in any appropriate number, and in any appropriate configuration, as described above. For example, the output features 216 can be processed as a layer input by a subsequent convolutional network layer.

FIG. 3 is a flow diagram of an example process for performing a sparse convolution. For convenience, the process 300 will be described as being performed by a system of one or more computers located in one or more locations. For example, a sparse convolution system, e.g., the sparse convolution system 200 of FIG. 2, appropriately programmed in accordance with this specification, can perform the process 300.

For convenience, the process 300 is described for a single filter in a single convolutional layer, which can be repeated for each of one or more filters in each of one or more convolutional layers.

The system can receive input features for the layer (302). For example, the system can receive input features which are sparse, and can arrange only the input features (e.g., represented by an ordered collection of numerical values, such as a vector or matrix of numerical values) which are above a ground state (e.g., a vector of all zeros) in an input matrix, where each row in the input matrix corresponds to a feature vector. Performing the convolution by processing only the inputs which are above the ground state can enable the system to perform the convolution with fewer computational resources (e.g., memory and processing power).

The system obtains a rule book tensor for input features for the layer (304). For example, the system can obtain a rule book tensor which specifies, for each filter spatial location of the filter of the layer, the respective input features which are multiplied by the filter spatial location, and, for each of the respective input features multiplied by the filter spatial location, the respective output feature that is generated at least in part on the multiplication of the input feature and the filter spatial location. The rule book tensor can be represented by, e.g., a tensor of dimensions F×N×2, as described above.

The system determines a first respective matrix size, a second respective matrix size, and a third respective matrix size (306) for generating the tile sets, i.e., the input tile set, the filter spatial location tile set, and the output tile set. More specifically, each tile in the input tile set generated from the input matrix corresponds to a matrix of the first matrix size, each tile in the filter spatial location tile set corresponds to a matrix of the second matrix size, and each tile in the output tile set corresponds to a matrix of the third matrix size.

For example, the system can determine the respective matrix sizes based on properties of the hardware accelerator chip, such as on-chip shared memory capacity, and on the input matrix, filter spatial location matrix, and output matrix themselves. In particular, the respective matrix sizes are determined such that a matrix of the first respective matrix size can be multiplied by a matrix of the second respective matrix size to generate a matrix of the third respective matrix size. Further, the sizes must be determined such that a matrix having any one of the respective matrix sizes can be stored fully in the on-chip shared memory for a thread block, as is described in further detail below.

The system performs the multiplication of each filter spatial location with the respective input features indicated by the rule book tensor, as is described in further detail below. For convenience, each of steps 306-314 are described as being performed “for the filter spatial location.” That is, the system performs steps 306-314 for each filter spatial location of the filter of the convolutional layer.

The system generates an input tile set that includes the respective input features (308) for the filter spatial location as indicated by the rule book tensor. For example, the system can arrange the respective input features in an input matrix, then generate an input tile set of the input matrix. The system can generate an input tile set of the input matrix by generating a set of matrices, each matrix in the set of matrices having the first matrix size and each matrix in the set of matrices corresponding to a tile in the input tile set, as is discussed in further detail below with reference to FIG. 4.

The system generates a filter spatial location tile set that includes the respective filter spatial location (310). For example, the system can generate a set of matrices, each matrix in the set of matrices having the second matrix size and each matrix in the set of matrices corresponding to a tile in the filter spatial location tile set, as is discussed in further detail below with reference to FIG. 4.

The system can generate an output tile set that includes the respective output features (312) for the filter spatial location as indicated by the rule book tensor. For each respective output feature for the filter spatial location, the system can include any output previously generated for the output feature based on another filter spatial location, or, if no output has yet been generated, the system can include a corresponding ground state vector, e.g., a vector of all zeros. For example, the system can arrange the respective output features in an output matrix, then generate an output tile set of the output matrix. The system can generate an output tile set of the output matrix by generating a set of matrices, each matrix in the set of matrices having the third matrix size and each matrix in the set of matrices corresponding to a tile in the output tile set, as is discussed in further detail below with reference to FIG. 4.

The system can generate a respective output for each output feature in the output tile set (314). For example, the system can generate a respective output feature for each output feature in the output tile set by multiplying the filter spatial location in the filter spatial location tile set by each input feature in the input feature tile set, as is discussed in further detail below with reference to of FIG. 4.

The system can write each output generated for output features in the output tile set to the position in global device memory corresponding to the spatial location of the output feature (316). The memory of the hardware accelerator chip is hierarchical, including global memory, shared memory for a thread block, and thread register memory, to accelerator computations, as is discussed in further detail below with reference to FIG. 4. For example, the system can supply the global device output addresses of the outputs to the kernel, and the system can write each output to the corresponding location in global device memory using atomic add instructions, so that the current output is added to any outputs already stored at the corresponding location. Each output feature is generated based at least in part on the multiplication of one filter spatial location with one input feature, and can have contributions from multiple such multiplications of filter spatial location and input feature pairs.

FIG. 4 is a diagram of an example data flow 400 for performing a sparse convolution on a hardware accelerator chip.

For convenience, the diagram illustrates the sparse convolution being performed for a single filter spatial location of a single filter for a single convolutional layer. In practice, the sparse convolution can be repeated for each filter spatial location for each filter for each convolutional layer in the convolutional neural network.

A hardware accelerator chip is a general purpose device designed to accelerate certain classes of programs, e.g., matrix multiply accumulate operations, or graphics related tasks, so that the hardware accelerator chip can perform the class of programs much more quickly than normal computing hardware. A kernel call to the hardware accelerator chip includes a list of instructions for how to perform an intended sequence of operations (e.g., including data objects, data object tags, operation instructions, memory locations, etc.). For example, a hardware accelerator chip, e.g., a graphics processing unit (GPU), can be designed to accelerate matrix operations, so that it can perform accelerated matrix multiplications for a neural network layer, e.g., for a convolutional neural network layer.

In some implementations, a hardware accelerator chip can perform the mathematical operations in parallel using multiple threads. The hardware accelerator chip can distribute parallelizable mathematical operations amongst the threads to further accelerate the mathematical operation. Each thread in the set of threads can have a respective thread register (i.e., block of memory) to store the information required to perform its portion of the mathematical operation.

In some implementations, a hardware accelerator chip having multiple threads can have a hierarchical memory structure. The set of threads on the hardware accelerator chip can include one or more disjoint subsets, each disjoint subset of threads represented by a thread block. The hierarchical memory can include a global device memory which is accessible by all threads, a block of shared memory for each thread block which is accessible only by threads in the thread block, and a thread register for each individual thread which is accessible only by the individual thread.

The diagram of FIG. 4 illustrates performing a sparse convolution of an input matrix 402 including only the respective input features for a filter spatial location and a filter spatial location matrix 404 including only the filter spatial location to generate an output matrix 406 including only the respective output features for the filter spatial location on a hardware accelerator chip 440. The input matrix 402, filter spatial location matrix 404, and output matrix 406 are stored in global device memory. The convolution can be performed on the hardware accelerator chip, e.g., by distributing the multiplication across one or more threads on the hardware accelerator chip 440 using a single kernel call for the filter spatial location 404. Performing the convolution using only a single kernel call to the hardware accelerator chip can enable the system to reduce the memory traffic necessary to perform the convolution, thereby reducing the amount of time the system spends waiting on memory transfer and enabling the system to take fuller advantage of the accelerated matrix multiplication of the hardware accelerator chip.

A hardware accelerator chip 440 can generate an input tile set of the input matrix 402, a filter spatial location tile set of the filter spatial location matrix 404, and an output tile set of the output matrix 406. Each tile in a respective tile set of a matrix can represent a subsection of the matrix (e.g., each tile can represent a 128×64 subsection of the matrix, such that the entire matrix is represented by the tile set). For example, the hardware accelerator chip 440 can generate each tile set by determining a respective matrix size for the tile set, e.g., a first matrix size for the input tile set, a second matrix size for the filter spatial location tile set, and a third matrix size for the output tile set. The respective matrix sizes can be determined based at least in part upon one or more properties of the hardware accelerator chip 440, e.g., on-chip thread block shared memory capacity, and so that a matrix of the first size can be multiplied with a matrix of the second size to generate a matrix of the third size. The hardware accelerator chip 440 can generate a respective tile set of a matrix by generating a corresponding set of matrices, where each matrix in the set of matrices is of the respective matrix size and where each matrix in the set of matrices corresponds to a tile in the respective tile set.

With reference to the example of FIG. 4, the hardware accelerator chip 440 can generate an input tile set corresponding to the input matrix 402, a filter spatial location tile set corresponding to filter spatial location matrix 404, and an output tile set corresponding to output matrix 406. An example tile from each tile set is highlighted in global device memory, in particular an input tile 412 of the input matrix 402, a filter spatial location tile 414 of the filter spatial location matrix 404, and an output tile 416 of the output matrix 406.

The hardware accelerator chip 440 can perform a sparse convolution operation by multiplying the particular filter spatial location in the filter spatial location tile set by the respective input features in the input tile set to generate the respective output features in the output tile set. For each output tile, the hardware accelerator chip can accumulate the multiplication of one or more input tile and filter spatial location tile pairs to generate the output tile. For example, if each tile includes only a single matrix element, the system can generate a particular output tile (i.e., a particular output matrix element) by accumulating the multiplication of the input tiles (i.e., input matrix elements) in the respective input matrix row with the filter spatial location tiles (i.e., filter spatial location matrix elements) in the respective filter spatial location column. That is, the system can perform a dot product between a respective row of the input matrix with a respective column of the filter spatial location matrix to generate the particular output matrix element.

In some implementations, the hardware accelerator chip 440 can perform the sparse convolution operation by iteratively transferring the respective input tiles and respective filter spatial location tiles processed to generate each respective output tile to the shared memory of a respective thread block. That is, for each output tile in the set of output tiles, the hardware accelerator chip 440 can transfer the output tile to the shared memory of a block of threads, then iteratively transfer the filter spatial location tile and input tile pairs multiplied to generate the output tile. With respect to the example of FIG. 4, the multiple input tiles and filter spatial location tiles multiplied to generate the output tile 416 are highlighted in global device memory using light gray, with the pair shown in thread block shared memory highlighted using medium gray in global device memory (i.e., input tile 412 and filter spatial location tile 414 in thread block shared memory).

For each respective input tile and filter spatial location tile pair multiplied to generate the respective output tile, the respective thread block can generate respective sets of partitions of each tile. Each partition in a respective set of partitions of a tile can represent a subsection of the tile (e.g., each partition can represent a subsection of the tile as a vector or matrix, such that the entire tile is represented by the set of partitions). For example, the respective thread block on the hardware accelerator chip 440 can generate a set of vector input partitions corresponding to the input tile 412, a set of vector filter spatial location partitions corresponding to the filter spatial location tile 414, and a set of matrix output partitions corresponding to the output tile 416. The respective size of the partitions in each set of partitions can, e.g., be based on one or more properties of the hardware accelerator chip 440, such as the thread register capacity, and such that the output product of an input partition and a filter spatial location partition can generate an output partition. With reference to the example of FIG. 4, each set of partitions is shown by dividing the respective tile into rectangles, each rectangle in the tile corresponding to a partition in the set of partitions of the tile. The input tile 412 is partitioned into vector partitions, including input partition 422, and the filter spatial location tile 414 is also partitioned into vector partitions, including filter spatial location partition 414. The output tile 416 is partitioned into matrix partitions, including output partition 426.

The hardware accelerator chip 440 can generate each output partition by iterating over the respective input partition and filter spatial location partition pairs processed to generate the output partition. The hardware accelerator chip can transfer the output partition and each respective partition pair to respective thread registers (i.e., memory) of threads in the thread block to generate the output for the output partition. For example, the hardware accelerator chip 400 can transfer each respective input partition and filter spatial location partition pair to respective thread registers of threads in the thread block, and accumulate the outer product of the partition pairs in the respective thread register of the output partition to generate the output for the output partition. With respect to the example of FIG. 4, the input partition 422, filter spatial location partition 424, and output partition 426 are each transferred to respective thread registers of threads in the thread block. The hardware accelerator chip 440 generates the outer product of the input partition 422 and filter spatial location partition 424, and accumulates the outer product with outer products already stored in the respective thread register of the output partition 426.

The hardware accelerator chip 440 can perform the outer product of the partition pair using hardware specific implementation. For example, for a Volta V100 GPU using Cutlass templates, the GPU can perform the matrix multiply accumulate using the CUDA Warp Matrix Multiply-Accumulate API (WMMA) across multiple tensor cores.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a sensor data input, the sensor data input comprising respective input features for each of a plurality of input spatial locations; and
processing the sensor data input using a convolutional neural network to generate a network output that characterizes the sensor data input, wherein the convolutional neural network comprises a first convolutional layer that is configured to perform a convolution between (i) respective input features for each of a set of input spatial locations for the first convolutional layer and (ii) a filter for the first convolutional layer that has a plurality of filter spatial locations to generate respective output features for each of a set of output spatial locations for the first convolutional layer, and wherein processing the sensor data input comprises:
obtaining a rule book tensor for the first convolutional layer that identifies, for each of the plurality of filter spatial locations, (i) a subset of the input features that are multiplied by the filter spatial location as part of performing the convolution and (ii) for each input feature in the subset, the respective output feature that is generated based at least in part on the multiplication between the input feature and the filter spatial location;
for each particular filter spatial location of the filter for the first convolutional layer:
generating an input tile set that includes only the respective input features that are identified in the rule book tensor for the particular filter spatial location;
generating a filter tile set that includes the particular filter spatial location;
generating an output tile set that includes only the respective output features that are identified in the rule book tensor for the particular filter spatial location; and
generating a respective output for each of the respective output features in the output tile set by multiplying the particular filter spatial location in the filter tile set with each of the input features in the input tile set; and
for each of the output features in the output tile set, writing the respective output for the output feature to a memory location in global device memory corresponding to the output feature.

2. The method of claim 1, wherein the respective input features for each of a set of input spatial locations for the first convolutional layer are arranged as rows in an input matrix with an accompanying set of tuples arranged as rows in an input coordinate matrix specifying the respective input spatial coordinates and the respective row in the input matrix of each input feature.

3. The method of claim 1, wherein each particular filter spatial location is arranged as a matrix of numerical values.

4. The method of claim 1, wherein the respective output features for each of a set of output spatial locations for the first convolutional layer are arranged as rows in an output matrix with an accompanying set of tuples arranged as rows in an output coordinate matrix specifying the respective output spatial coordinates and the respective row in the output matrix of each output feature.

5. The method of claim 1, wherein obtaining a rule book tensor for the first convolutional layer comprises iterating over each input feature to determine (i) the respective subset of output features generated based at least in part on the input feature, and (ii) for each output feature in the respective subset, which filter spatial location is multiplied by the input feature to generate the respective output feature.

6. The method of claim 5, wherein the rule book tensor for the first convolutional layer is arranged as a set of matrices, each matrix specifying for a particular filter spatial location a set of input-output tuples arranged as rows in the matrix, each input-output tuple defining (i) which respective row of the input matrix is multiplied by the particular filter spatial location to generate, at least in part, (ii) which respective row of the output matrix.

7. The method of claim 1, wherein generating an input tile set that includes only the respective input features that are identified in the rule book tensor for the particular filter spatial location comprises:
arranging only the respective input features identified in the rule book tensor for the particular filter spatial location as rows in a respective input matrix;
determining a first respective matrix size; and
generating, from the respective input matrix, a set of matrices, each matrix in the set of matrices having the first respective matrix size and each matrix in the set of matrices corresponding to a respective tile in the set of input tiles.

8. The method of claim 7, wherein generating a filter tile set that includes the particular filter spatial location comprises:
determining a second respective matrix size; and
generating, from the particular filter spatial location matrix, a set of matrices, each matrix in the set of matrices having the second respective matrix size and each matrix in the set of matrices corresponding to a respective tile in the set of filter tiles.

9. The method of claim 8, wherein generating an output tile set that includes only the respective output features that are identified in the rule book tensor for the particular filter spatial location comprises:
arranging only the respective output features identified in the rule book tensor for the particular filter spatial location as rows in a respective output matrix;
determining a third respective matrix size; and
generating, from the respective output matrix, a set of matrices, each matrix in the set of matrices having the third respective matrix size and each matrix in the set of matrices corresponding to a respective tile in the set of output tiles.

10. The method claim 9, wherein the processing is performed at least in part on a hardware accelerator chip, and wherein the first, second, and third respective matrix sizes are determined based on one or more properties of the hardware accelerator chip

11. The method of claim 1, wherein generating a respective output for each of the respective output features in the output tile set by multiplying the particular filter spatial location in the filter tile set with each of the input features in the input tile set comprises:
for each output tile in the set of output tiles:
transferring the output tile to the shared memory for a respective thread block;
for each input tile in the respective input tile set processed to generate the output tile:
transferring the respective input tile in the input tile set to the shared memory for the respective thread block;
for each input tile in the respective filter tile set processed with respect to the respective input tile to generate the respective output tile:
transferring the respective input tile in the respective filter tile set to the shared memory for the respective thread block.

12. The method of claim 11, wherein generating a respective output for each of the respective output features in the output tile set by multiplying the particular filter spatial location in the filter tile set with each of the input features in the input tile set further comprises:
for each output tile in the set of output tiles:
generating a set of output partitions by partitioning the output tile transferred to the respective thread block among the registers of the respective threads in the respective thread block;
for each input tile in the respective input tile set processed to generate the output tile:
generating a set of input partitions by partitioning the respective input tile transferred to the respective thread block among the respective registers of the respective threads in the respective thread block;
for each input tile in the respective filter tile set processed with respect to the respective input tile to generate the respective output tile:
generating a set of filter partitions by partitioning the respective filter tile transferred to the respective thread block among the respective registers of the respective threads in the respective thread block;
for each of a plurality of pairs of partitions, each pair comprising a respective first partition from the set of input partitions of the input tile set and a respective second partition from the set of filter partitions from the filter tile set:
generating an inner product of the pair of partitions; and
accumulating the result of the inner product in the respective register corresponding to the respective partition of the output tile.

13. The method of claim 12, wherein accumulating the result of the inner product in a respective register corresponding to the respective partition of the output tile comprises adding the respective inner product to any inner products already stored in the register.

14. The method of claim 12, wherein writing the respective output for the output feature to the memory location in global device memory corresponding to the output feature comprises:
generating the respective output, comprising transferring the partitions of the respective output tiles corresponding to the output feature from the registers of the respective threads of the respective thread block to the shared memory of the thread block; and
adding the respective output to any outputs already stored in the respective memory location in global device memory corresponding to the output feature.

15. A system comprising:
one or more computers; and
one or more storage devices communicatively coupled to the one or more computers, wherein the one or more storage devices store instructions that, when executed by the one or more computers, cause the one or more computers to perform operations for performing an accelerated convolution for sparse inputs, the operations comprising:
receiving a sensor data input, the sensor data input comprising respective input features for each of a plurality of input spatial locations; and
processing the sensor data input using a convolutional neural network to generate a network output that characterizes the sensor data input, wherein the convolutional neural network comprises a first convolutional layer that is configured to perform a convolution between (i) respective input features for each of a set of input spatial locations for the first convolutional layer and (ii) a filter for the first convolutional layer that has a plurality of filter spatial locations to generate respective output features for each of a set of output spatial locations for the first convolutional layer, and wherein processing the sensor data input comprises:
obtaining a rule book tensor for the first convolutional layer that identifies, for each of the plurality of filter spatial locations, (i) a subset of the input features that are multiplied by the filter spatial location as part of performing the convolution and (ii) for each input feature in the subset, the respective output feature that is generated based at least in part on the multiplication between the input feature and the filter spatial location;
for each particular filter spatial location of the filter for the first convolutional layer:
generating an input tile set that includes only the respective input features that are identified in the rule book tensor for the particular filter spatial location;
generating a filter tile set that includes the particular filter spatial location;
generating an output tile set that includes only the respective output features that are identified in the rule book tensor for the particular filter spatial location; and
generating a respective output for each of the respective output features in the output tile set by multiplying the particular filter spatial location in the filter tile set with each of the input features in the input tile set; and
for each of the output features in the output tile set, writing the respective output for the output feature to a memory location in global device memory corresponding to the output feature.

16. The system of claim 15, wherein the respective input features for each of a set of input spatial locations for the first convolutional layer are arranged as rows in an input matrix with an accompanying set of tuples arranged as rows in an input coordinate matrix specifying the respective input spatial coordinates and the respective row in the input matrix of each input feature.

17. The system of claim 15, wherein each particular filter spatial location is arranged as a matrix of numerical values.

18. The system of claim 15, wherein the respective output features for each of a set of output spatial locations for the first convolutional layer are arranged as rows in an output matrix with an accompanying set of tuples arranged as rows in an output coordinate matrix specifying the respective output spatial coordinates and the respective row in the output matrix of each output feature.

19. The system of claim 15, wherein obtaining a rule book tensor for the first convolutional layer comprises iterating over each input feature to determine (i) the respective subset of output features generated based at least in part on the input feature, and (ii) for each output feature in the respective subset, which filter spatial location is multiplied by the input feature to generate the respective output feature.

20. One or more non-transitory computer storage media encoded with computer program instructions that when executed by a plurality of computers cause the plurality of computers to perform operations for performing an accelerated convolution for sparse inputs, the operations comprising:
receiving a sensor data input, the sensor data input comprising respective input features for each of a plurality of input spatial locations; and
processing the sensor data input using a convolutional neural network to generate a network output that characterizes the sensor data input, wherein the convolutional neural network comprises a first convolutional layer that is configured to perform a convolution between (i) respective input features for each of a set of input spatial locations for the first convolutional layer and (ii) a filter for the first convolutional layer that has a plurality of filter spatial locations to generate respective output features for each of a set of output spatial locations for the first convolutional layer, and wherein processing the sensor data input comprises:
obtaining a rule book tensor for the first convolutional layer that identifies, for each of the plurality of filter spatial locations, (i) a subset of the input features that are multiplied by the filter spatial location as part of performing the convolution and (ii) for each input feature in the subset, the respective output feature that is generated based at least in part on the multiplication between the input feature and the filter spatial location;
for each particular filter spatial location of the filter for the first convolutional layer:
generating an input tile set that includes only the respective input features that are identified in the rule book tensor for the particular filter spatial location;
generating a filter tile set that includes the particular filter spatial location;
generating an output tile set that includes only the respective output features that are identified in the rule book tensor for the particular filter spatial location; and
generating a respective output for each of the respective output features in the output tile set by multiplying the particular filter spatial location in the filter tile set with each of the input features in the input tile set; and
for each of the output features in the output tile set, writing the respective output for the output feature to a memory location in global device memory corresponding to the output feature.
